(19) United States
(12) Patent Application Publication
(10) Pub. No.: US 2003/0051128 A1
(43) Pub. Date: Mar. 13, 2003

(54) Method and apparatus for managing client computers in a distributed data processing system

(76) Inventors: Herman Rodriguez, Austin, TX (US); Joel Leslie Smith, Round Rock, TX (US)

Correspondence Address: Duke W. Yee, Carstens, Yee & Cahoon, L.L.P., P.O. Box 802334, Dallas, TX, 75380, US

(21) Appl. No.: 10/262,283

(22) Filed: Sep. 30, 2002

Related U.S. Application Data
(62) Division of application No. 09/282,693, filed on Mar. 31, 1999.

(51) Int. Cl. G06F 9/00; G06F 1/24

(52) U.S. Cl. 713/100

(57) ABSTRACT

A method and apparatus for maintaining a system image for the computer. An initial state of the system image is identified. Responsive to an event, a determination is made as to whether a present state of the system image has changed from the initial state of the system image. Responsive to a change between the initial state of the system image and the current state of the system image, an update of the system image is sent for storage.

### BACKGROUND OF THE INVENTION

1. Technical Field

The present invention relates generally to an improved distributed data processing system and in particular to a method and apparatus for managing computers in a distributed data processing system. Still more particularly, the present invention provides a method and apparatus for loading and managing operating environments on computers in a distributed data processing system.

2. Description of Related Art

A computer includes both a physical machine, namely the hardware, and the instructions which cause the physical machine to operate, namely the software. Software includes both application and operating system programs. If the program is to do tasks for a user, such as solving specific problems, it is referred to as application software. If a program controls the hardware of the computer and the execution of the application programs, it is called operating system software. System software further includes the operating system, the program that controls the actual computer or central processing unit (CPU), and device drivers, which control the input and output devices (I/O) such as printers and terminals.

A general-purpose computer is fairly complicated. Usually a queue of application programs is present waiting to use the CPU. The operating system will need to determine which program will run next, how much of the CPU time it will be allowed to use and what other computer resources the application will be allowed to use. Further, each application program will require a special input or output device and the application program must transfer its data to the operating system, which controls the device drivers.

When a computer is booted, a boot program stored in a read only memory (ROM) is used to initiate loading of the operating system onto the computer's memory. The term “boot” refers to the process of starting or resetting a computer. When first turned on (cold boot) or reset (warm boot), the computer executes the software that loads and starts the computer's more complicated operating system and prepares it for use. Thus, the computer can be said to pull itself up by its own bootstraps. The boot program instructs the computer where to find a larger boot program also called a “boot block” data program, which is used to load the operating system onto the computer. The term “boot block” refers to a portion of a disk that contains the operating-system loader and other basic information that enables a computer to start up. In stand-alone computers, the boot block program and the operating system are found on a local hard drive.

A network containing a number of computers may be formed by having these computers, also referred to as “nodes” or “network computers”, communicate with each other over one or more communications links, which is an aggregation which is a computer network. Today, many computer workstations are connected to other workstations, file servers, or other resources over a local area network (LAN). Each computer on a network is connected to the network via an adapter card or other similar means, which provides an ability to establish a communications link to the network.

In managing network computers (NCs), it is desirable to maintain uniformity of programs, operating systems, and configurations among the different NCs. In maintaining uniformity, a technique of using remote boot operations may be employed to support NCs in a network environment. In such a case, each network computer (NC) is booted from a remote boot disk or other device located elsewhere on the network, such as on a server or a disk array system connected to the network. Such a boot system also provides for minimizing the amount of time needed to update individual NCs because system administrators do not have to physically reconfigure or change applications at each NC. Additionally, the remote boot processes provide support for completely diskless NCs. Furthermore, the remote boot process enhances software and network security because the remote boot files may be kept in a secure location and copies do not need to be distributed among NCs in the network.

In such a network environment, a user may move from one NC to another, which is also referred to as “roaming”. When a user roams to a new NC, the user's environment is set to a restart mode in which a boot image is used to boot the NC. Further, the user must restart applications and reopen documents and databases at the new NC. The restarting of applications and other resources can detract from the user's experience, causing unnecessary difficulty in picking up or continuing tasks at a new NC. The recreation of the user's environment is time consuming and cumbersome. Further, the load on a server increases because the boot image for the NC and applications must be retrieved from the server system and restarted on the client NC. The time for these operations can be quite lengthy. Further more, the starting and stopping of application programs imposes a significant load on the server resource system, particularly on the file system at the server.

Therefore, it would be advantageous to have an improved method and apparatus for allowing a user to move or roam from one computer to another.

### SUMMARY OF THE INVENTION

The present invention provides a method and apparatus for maintaining a system image for the computer. An initial state of the system image is identified. Responsive to an event, a determination is made as to whether a present state of the system image has changed from the initial state of the system image. Responsive to a change between the initial state of the system image and the current state of the system image, an update of the system image is sent for storage.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 is a block diagram depicting a data processing system, which may be implemented as a server, in accordance with a preferred embodiment of the present invention;

FIG. 3 is a block diagram illustrating a data processing system in which the present invention may be implemented;

FIG. 4, is a block diagram illustrating images on both a server and client depicted in accordance with a preferred embodiment of the present invention;

FIG. 5 is a diagram of an image depicted in accordance with a preferred embodiment of the present invention;

FIG. 6 is a flowchart of a process for setting up a user account depicted in accordance with a preferred embodiment of the present invention;

FIG. 7 is a flowchart of a process for storing snapshot images depicted in accordance with a preferred embodiment of the present invention;

FIG. 8 is a flowchart of a process for updating images depicted in accordance with a preferred embodiment of the present invention;

FIG. 9 is a flowchart of a process for sending snapshot images to a client depicted in accordance with a preferred embodiment of the present invention;

FIG. 10 is a flowchart of a process for pre-loading images depicted in accordance with a preferred embodiment of the present invention;

FIG. 11 is a flowchart of a process for restoring an image on a client depicted in accordance with a preferred embodiment of the present invention; and

FIG. 12 is a flowchart of a process used to send updates to a server depicted in accordance with a preferred embodiment of the present invention.

### DETAILED DESCRIPTION OF THE PREFERRED EMBODIMENT

With reference now to the figures, FIG. 1 depicts a pictorial representation of a distributed data processing system in which the present invention may be implemented. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections.

In the depicted example, a server 104 is connected to network 102 along with storage unit 106. In addition, network computers (NCs) 108, 110, and 112 also are connected to a network 102. These NCs 108, 110, and 112 may be, for example, personal computers or network computers. For purposes of this application, a network computer is any computer, coupled to a network, which receives a program or other application from another computer coupled to the network. In the depicted example, server 104 provides data, such as boot files, operating system images, and applications to NCs 108-112. NCs 108, 110, and 112 are clients to server 104. Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, distributed data processing system 100 also may be implemented as a number of different types of networks, such as for example, an intranet, a local area network (LAN), or a wide area network (WAN). FIG. 1 is intended as an example, and not as an architectural limitation for the present invention.

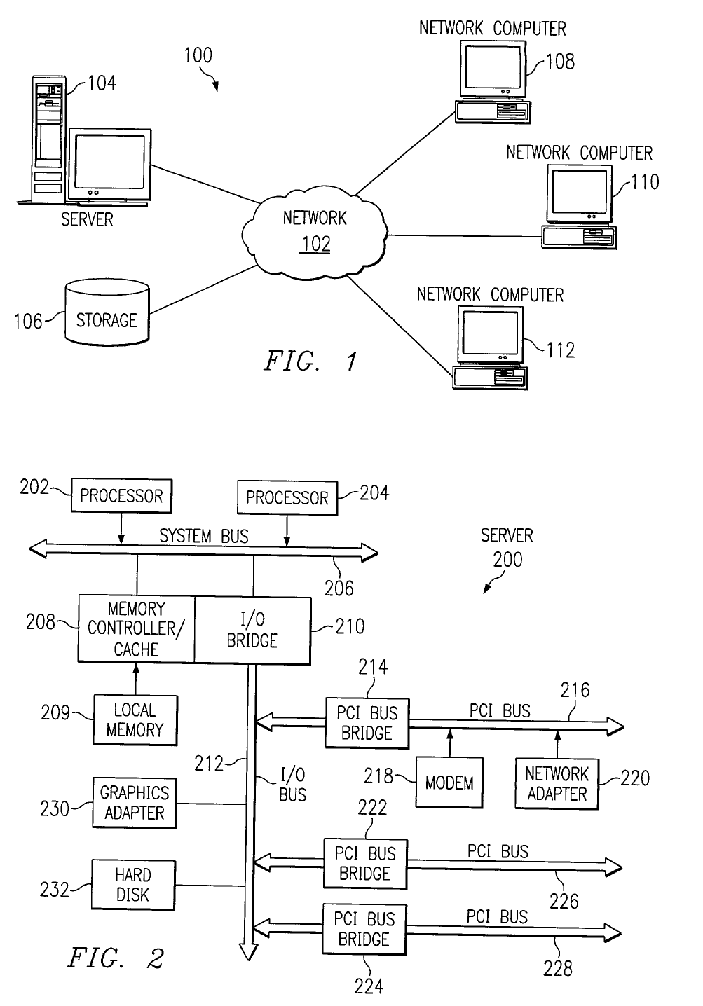

Referring to FIG. 2, a block diagram depicts a data processing system, which may be implemented as a server, such as server 104 in FIG. 1, in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

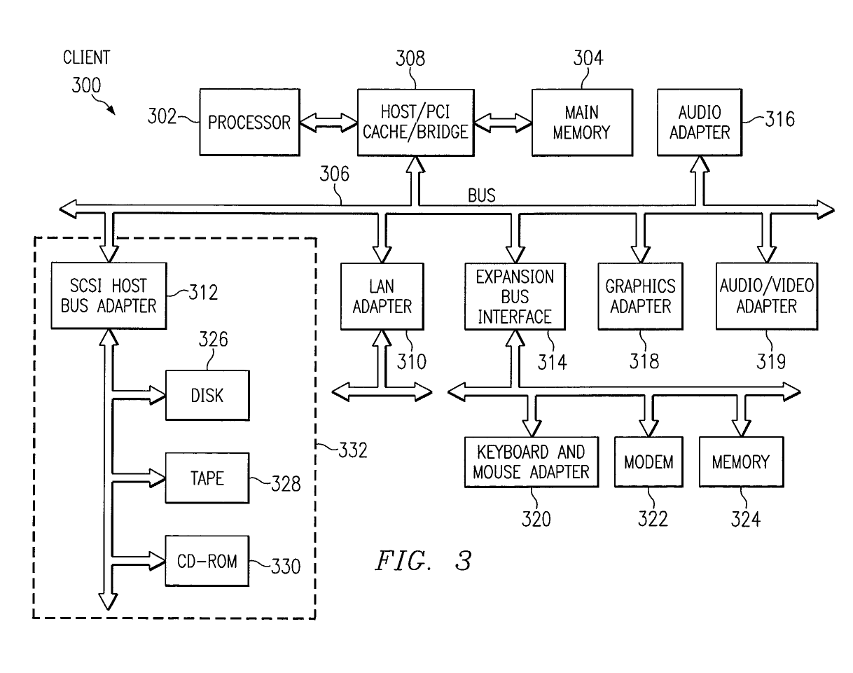

With reference now to FIG. 3, a block diagram illustrates a data processing system in which the present invention may be implemented. Data processing system 300 is an example of a client computer. Data processing system 300 employs a peripheral component interconnect (PCI) local bus architecture. Although the depicted example employs a PCI bus, other bus architectures such as Micro Channel and ISA may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system such as OS/2, which is available from International Business Machines Corporation. “OS/2” is a trademark of International Business Machines Corporation. An object oriented programming system such as Java may run in conjunction with the operating system and provides calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, when implemented as a NC, data processing system 300 will typically include fewer components than those illustrated in FIG. 2. For example, many NCs may be diskless or contain only a single storage device, such as hard disk drive 226 in FIG. 2.

For example, data processing system 300, if optionally configured as a network computer, may not include SCSI host bus adapter 312, hard disk drive 326, tape drive 328, and CD-ROM 330, as noted by dotted line 332 in FIG. 3 denoting optional inclusion. In that case, the computer, to be properly called a client computer, must include some type of network communication interface, such as LAN adapter 310, modem 322, or the like. As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device which is configured with ROM and/or flash ROM in order to provide non-volatile memory for storing operating system files and/or user-generated data.

The depicted example in FIG. 3 and the above-described examples are not meant to imply architectural limitations.

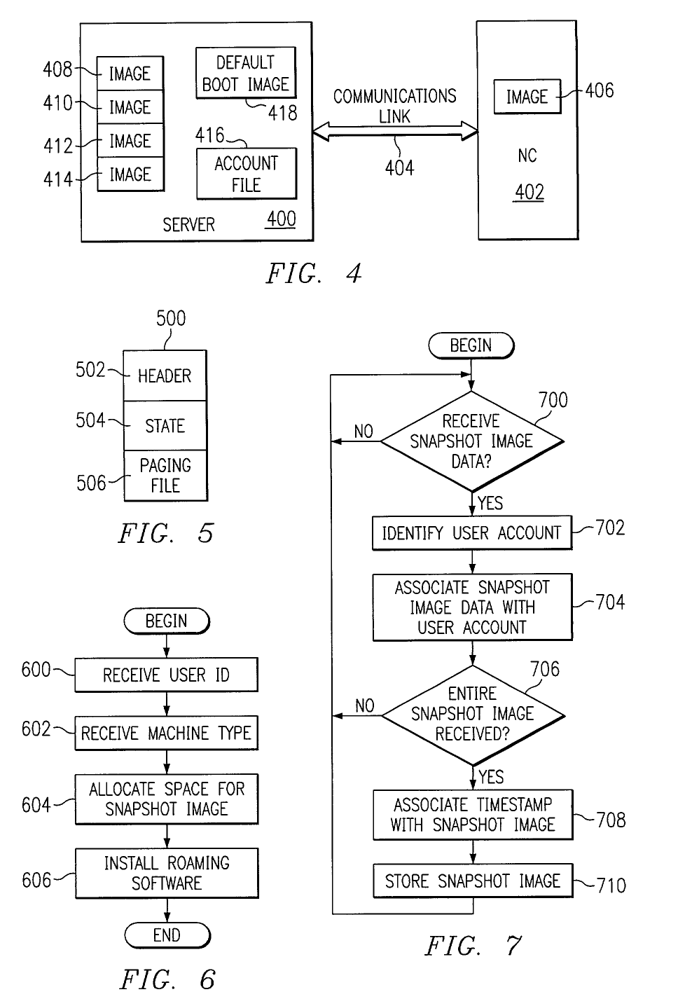

The present invention provides a method, apparatus, and instructions for allowing a user to easily roam from one computer to another in a distributed data processing system. In particular with reference to FIG. 4, server 400 is in communication with NC 402 via communications link 404. NC 402 includes image 406, which is a complete collection of the user operating environment, including for example, system memory, disk images, register images, connection to remote devices, and network and processor states. A snapshot or copy of image 406 is made from NC 402 to form a snapshot image, which is stored on server 400. Server 400 stores a number of snapshot images 408, 410, 412, and 414 in the depicted example. A snapshot image of NC 402 is a copy of the user environment on NC 402 as represented by image 406. This snapshot image is made on some periodic basis or in response to selected events during a user's session on NC 402. The periodic snapshot may be made in response to an expiration of a timer and events causing a snapshot which may include, for example, a user logging off an NC, a user requesting a snapshot, an NC about to enter a low-power or standby mode. The initial snapshot image may be created by the client sending incremental changes to the server until a complete image is stored on the server. Each user has an account on server 400 stored in account file 416. In the depicted example, this file includes a user ID, a machine type for the user NC, and an identification of the location and/or space allocated for the snapshot image.

In updating images, such as snapshot images 408-414, the update may be a replacement image taken from NC 402 or the update may take the form of changes to image 406 on NC 402.

When a user logs on to a NC, such as NC 402, a determination is made as to whether a snapshot image is available for use on the particular NC. If the snapshot image is available, the snapshot image is sent to the NC. A snapshot image may be unavailable because no snapshot image is present. In addition, a snapshot image may be unavailable because the machine type associated with the snapshot image stored for the user does not match the machine type at which the user has logged on. Otherwise, a default boot image 418 is sent to the NC. In such a case, the user must restart applications and reopen resources to return to a desired state.

With reference to FIG. 5, a diagram of an image is depicted in accordance with a preferred embodiment of the present invention. Image 500 is an example of an image on a client, such as image 406 on NC 402 in FIG. 4. Image 500 may be stored as a snapshot image on a server such as server 400 in FIG. 4. Image 500 is an image used to place a computer, such as NC 402, into a selected state. Image 500 in this example includes header information 502, state information 504, and paging file information 506. Header information 502 describes the file layout and loading information for the image on the NC, while state information 504 contains the state of the physical memory and hardware devices within the NC (i.e. devices used by the operating system, interrupts, and network based real time clock). State information 504 may be obtained using known hibernation techniques, such as those described in U.S. Pat. No. 5,822,582

Image 500 will include paging file information 506 only for systems involving virtual memory management. Paging file information within image 500 may be the paging file itself. Alternatively, a part of the paging file may be frozen or locked from changes in which the locked portion of the paging file contains information needed to restore, boot, or unhibernate the NC. Although the depicted example employs a paging file, a paging space may be used in place of a paging file depending on the type of operating system. A paging space or paging file is applicable to systems with virtual memory managers.

FIGS. 6-10 are flowcharts of processes used at a server to manage images from clients within a distributed data processing system. These processes include the setting up of user accounts, receiving and storing images as well as sending images to clients. Further, the processes at the server may be used to pre-load images in the event a user is expected to be at a selected client at specific times.

With reference now to FIG. 6, a flowchart of a process for setting up a user account is depicted in accordance with a preferred embodiment of the present invention. The user account is typically created by a system administrator on a server for a user. In this manner, users with accounts are able to roam from client to client without incurring the time penalty associated with having to reopen resources or create works in progress. The process begins by receiving a user ID (step 600). Thereafter, machine type is received for the user (step 602). The machine type is used to identify the type of computer or NC at which the user is located. Then, space is allocated for the snapshot image (step 604), and roaming software is installed at the computer or NC at which the user is located (step 606) with the process terminating thereafter.

With reference now to FIG. 7, a flowchart of a process for storing snapshot images is depicted in accordance with a preferred embodiment of the present invention. The process begins by determining whether a system snapshot image has been received (step 700). If a system snapshot image has not been received, the process continues to return to step 700. Otherwise, a user account is identified for the snapshot image (step 702). The snapshot image is unique for each user ID. The header in the snapshot image identifies the file on the server that contains the image. The header in the snapshot image may include identification information, such as the user ID, the node ID, and the session (snapshot) ID. After identifying the user account for the snapshot image data, the user account is associated with the snapshot image data (step 704). Thereafter, a determination is made as to whether the entire snapshot image has been received (step 706). During the implementation, the process may receive the entire image at once or may receive the image incrementally from the client. If the entire image has not been received, the process returns to step 700 to determine whether additional snapshot image data has been received. Otherwise, a timestamp is associated with the snapshot image (step 708). The timestamp is used to synchronize changes to the snapshot image on the server. The timestamp is required because in many cases, changes to the snapshot image are queued up in the server for processing by the server to apply these changes to the snapshot image. As a result, the timestamp is relevant to identify which changes should be made. For example, if the update to the image has a timestamp that is older than that of the snapshot image, the update would not be used.

Next, the snapshot image is stored (step 710) with the process then returning to step 700. The snapshot image is a collection of the complete user's operating environment and may include for example, a copy of the memory, a copy of the state of the registers, connections to remote drives, a copy of the any storage devices located at the client, and any active applications or other open resources. Turning next to FIG. 8, a flowchart of a process for updating images is depicted in accordance with a preferred embodiment of the present invention. The snapshot image is then closed after the image has been updated. The process begins by receiving an update to a snapshot image (step 800). Next, a user account is identified for the update (step 802). The snapshot image associated with the user account is then opened to allow for changes to the user account (step 804). The snapshot image associated with the user account is updated (step 804) with the process terminating thereafter. This update may take the form of a new snapshot image or may contain only changes to the image on the NC. The initiation of sending the update is handled by the roaming software of the NC as will be described in more detail below. The opening and closing of a snapshot image also may be performed upon user login and user logout, respectfully. In such a case, the snapshot image is closed when a user logs off the network so that the snapshot image may be saved as a complete entity until the user logs on to the network next time. When the user logs on to the network, the snapshot image is opened to allow changes to the snapshot image.

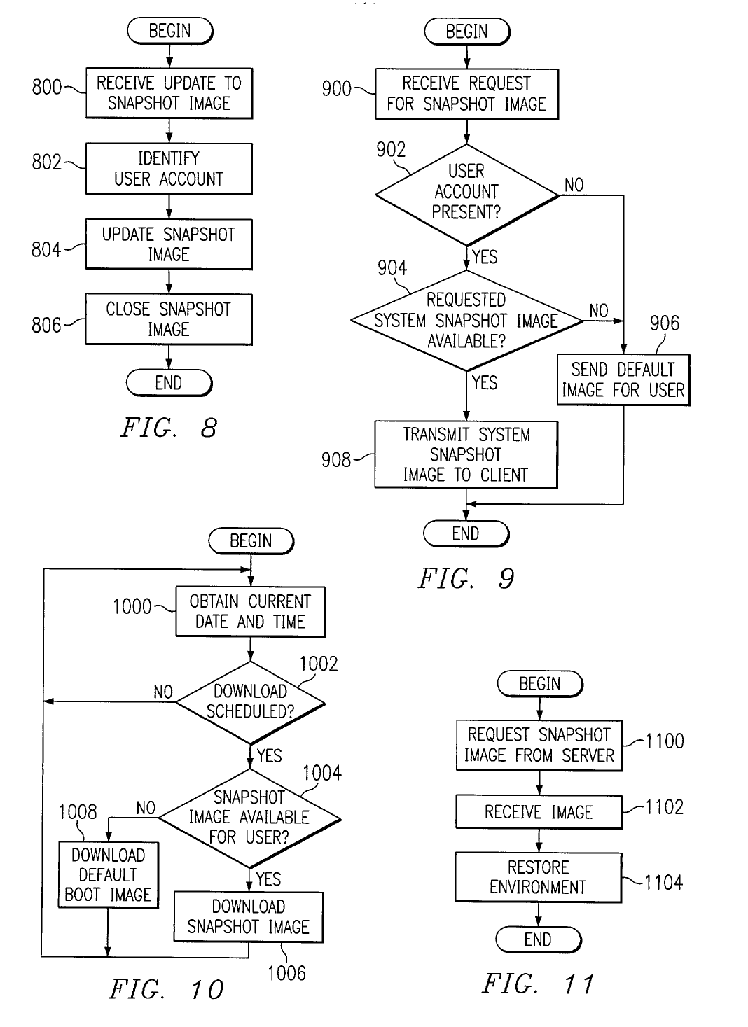

In FIG. 9, a flowchart of a process for sending snapshot images to a client is depicted in accordance with a preferred embodiment of the present invention. The process begins by receiving a request for a snapshot image (step 900). This request may be automatically initiated by the client when a user logs on to the client. Additionally, the request might also be scheduled so that the snapshot image is downloaded to the user's NC at some predetermined time, thus minimizing standby time. In this example, the request includes a user ID of the user at the client. Thereafter, a determination is made as to whether a user account is present (step 902). If a user account is present, the process then determines whether a snapshot image is available (step 904). This determination includes determining whether a snapshot image is present and whether the snapshot image is for the correct machine type. The user may have created a snapshot image at a prior client having a different machine type from the present client. If a snapshot image is not available, a default boot image is sent to the client (step 906) with the process terminating thereafter.

With reference again to step 904, if the requested snapshot image is available, the snapshot image is sent to the client (step 908) with the process terminating thereafter. With reference again to step 902, if a user account is not present, then the process proceeds to step 906 to send a default image to the client.

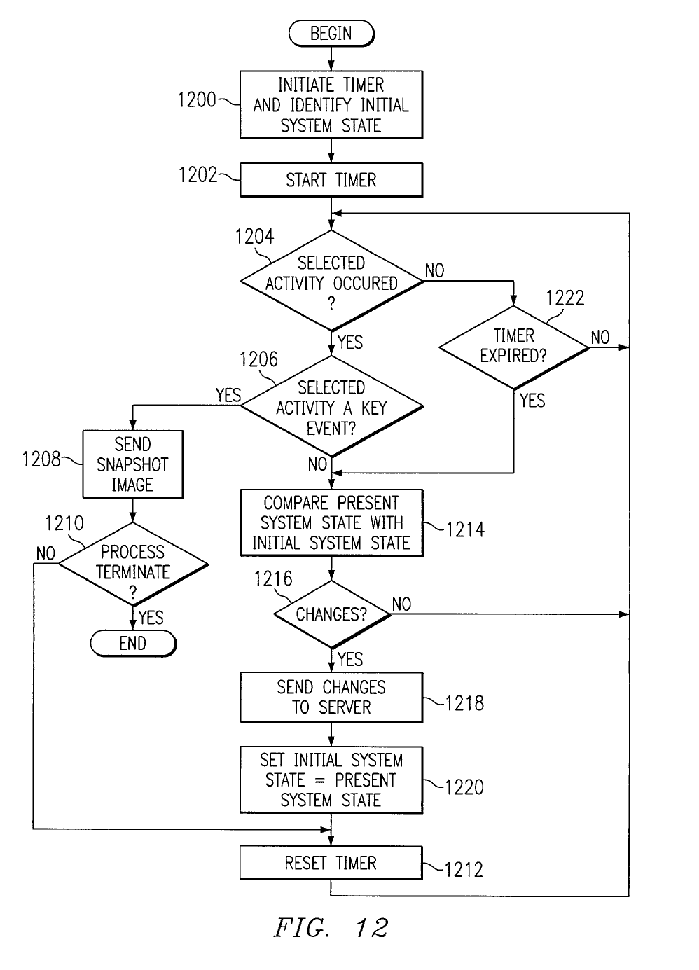

With reference now to FIG. 10, a flowchart of a process for pre-loading images is depicted in accordance with a preferred embodiment of the present invention. This process may be used to pre-fetch a snapshot image and load it on a client if the user is expected to be at the client at a pre-set time. This process may further minimize the time and effort needed to allow a user to start working on a client.

The process begins by obtaining the current date and time (step 1000). A determination is then made as to whether an image download is scheduled for the client at the current date and time (step 1002). If a download is not scheduled, the process returns to step 1000. Otherwise, a determination is made as to whether a snapshot image is available for the user (step 1004). If a snapshot image is available, the snapshot image is then downloaded to the client (step 1006) with the process then returning to step 1000. Otherwise, a default boot image is downloaded to the client (step 1008) with the process then returning to step 1000.

FIGS. 11 and 12 are flowcharts of processes used by roaming software to process images at a client. The process includes requesting a snapshot image as well as sending updates to a server for storage. These processes run in the background of the user operating environment and are used to send updates (e.g. changes or entire images) back to a server.

Turning next to FIG. 11, a flowchart of a process for restoring an image on a client is depicted in accordance with a preferred embodiment of the present invention. The process begins by requesting a snapshot image from the server (step 1100). This request may be accomplished using a variety of known mechanisms for remote booting or initiation of computers, such as for example, Remote Initial Program Load (RIPL), which is typically used to load an operating system from a server to a client. This process can be used to load the snapshot image. Thereafter, the image is received from the server (step 1102). This image may be a snapshot image or a default boot image, depending on whether a snapshot image is available for the user at this particular client. Next, the user operating environment is restored (step 1104) with the process terminating thereafter. The restoring of the user operating environment may be a complete restoration when a snapshot image is available. Otherwise, the restoration is only partial because the user will still be required to reopen some applications and other resources.

With reference now to FIG. 12, a flowchart of a process used to send updates to a server is depicted in accordance with a preferred embodiment of the present invention. A policy may be used to initiate creation and sending of an update, such as a snapshot image or data containing changes to the computer system. This policy may initiate the update in a number of ways, such as, for example, periodically or in response to an occurrence of a selected event. The process begins by initiating a timer and identify an initial system state (step 1200). The timer is used to cause periodic updates to the snapshot image while the initial system state is used to identity changes in the user's operating environment. Next, the timer is started (step 1202). Then, a determination is made as to whether a selected activity has occurred (step 1204). If a selected activity has occurred, then a determination is made as to whether this selected activity is a key event (step 1206). A key event may include a number of events, including, for example, a log in to the client, a log out from the client, an application load, unloading of an application, or a state in which the client is about to enter a low power mode.

If the activity is a key event, then a snapshot image of the client is sent to the server (step 1208). Then, a determination is made as to whether the process should terminate (step 1210). In the depicted example, the process would terminate in event that the user logs out from the client. If the process does not terminate, then the timer is reset (step 1212) with the process then returning to step 1204.

With reference again to step 1206, if the selected activity is not a key event, the process then compares the present system state with the initial system state (step 1214). This step examines the present state of the user operating environment with the initial state identified in step 1200. Differences, such as, for example, without limitation, changes in registers, changes in memory, or changes in open resources are examined in the comparison. A determination is then made as the whether changes are present between the different states in the user operating environment (step 1216). If changes between the states are not present, the process returns to step 1204.

Otherwise, the changes identified by the comparison in step 1214 are sent to the server (step 1218). Then, the initial system state is set equal to the present system state (step 1220) with the process then proceeding to step 1212 as previously described.

With reference again to step 1204, if a selected activity has not occurred, a determination is made as to whether the time has expired (step 1222). If the timer has not expired, the process returns to step 1204. Otherwise, the process proceeds to step 1214 to compare the present system state with the initial system state.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Although the depicted examples are directed towards NCs, the processes of the present invention may be applied to other types of computers, such as a personal computer connected to a network. For example, the process of the present invention may be applied to a portable computer, such as a laptop computer. For example, a user may be logged on at a first location and a snapshot image and other updates sent to a host or server computer for storage. The user may then log off the portable computer, disconnect the computer, move to another location, reconnect the portable computer, and login. This login at the second location would result in the snapshot image being sent down to the portable computer at the second location. Further, the snapshot image in the depicted example included the entire operating environment, i.e., contents of volatile memory, register states, and persistent storage. Depending on the implementation the snap shot image may only be that of the persistent storage, such as hard disk drives or volatile memory in the case of a network computer that has no local permanent storage. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a computer for maintaining a system image for the computer, the method comprising the computer implemented steps of:
identifying an initial state of the system image;
responsive to an event, determining whether a present state of the system image has changed from the initial state of the system image; and
responsive to a change between the initial state of the system image and the current state of the system image, sending an update of the system image to a remote computer for storage.

2. The method of claim 1, wherein the step of sending an update comprises:
sending the change for storage.

3. The method of claim 1, wherein the step of sending an update comprises:
sending a snapshot of the system image for storage.

4. The method of claim 1, wherein the remote computer is a server computer.

5. The method of claim 1, wherein the event is a periodic event.

6. The method of claim 1, wherein the event is a request from a user to update the image.

7. The method of claim 1, wherein the event is a log off of the computer.

8. The method of claim 1, wherein the computer includes registers and wherein the system image includes a state of the registers.

9. The method of claim 1, wherein active applications are present on the computer and wherein the system image includes the active applications.

10. A method in a host computer for maintaining system images for a plurality of users at a plurality of client computers in a distributed data processing system, the method comprising the computer implemented steps of:
maintaining a plurality of system images for the plurality of users within the host computer, wherein each system image within the plurality of system images is associated with a user within the plurality of users;
monitoring for a reception of an update to a system image from a client computer within the plurality of client computers;
responsive to detecting the reception of the update to a system image, identifying a system image within the plurality of system images that is associated with the update; and
responsive to identifying the system image associated with the update, changing the system image to reflect the update.

11. The method of claim 10, wherein the update is a new system image.

12. The method of claim 10, wherein the update is a change to the system image.

13. The method of claim 10, wherein the update includes a state of registers in the client computer.

14. The method of claim 10, wherein the update includes a state of memory in a client computer.

15. The method of claim 10 further comprising:
monitoring for a login by a user at a client computer;
responsive to detecting a login by the user, determining whether a system image for the user is present;
responsive to determining that the system image for the user is present, sending the image to the client computer.

16. The method of claim 15 further comprising:
responsive to determining the system image for the user is absent, sending a default image to the client computer.

17. The method of claim 15, wherein the login by the user is at a new client computer that is different from the client computer from which the update to the system image was received.

18. The method of 15, wherein the client computer is a portable computer and wherein the user logs off the portable computer at a first location and performs the logon at a second location.

19. A method for computing in a distributed data processing system, the method comprising:
creating a snapshot image of a first client computer within the distributed data processing system according to a policy;
storing the snapshot image on a server computer within the distributed data processing system in association with a user;
responsive to a log on by the user to a second client computer within the distributed data processing system, determining whether the snapshot image is available; and
responsive to determining that the snapshot image is available, loading the snapshot image onto the second client computer.

20. The method of claim 19, wherein the snapshot image includes system memory, disk images, and network and processor states.

21. The method of claim 19 further comprising creating the snapshot image of the first client computer in response to an occurrence of a selected event in the first client computer.

22. The method of claim 19, wherein the first client computer has a machine type, the second client computer has a machine type, and wherein the step of determining whether the snapshot image is available comprises:
determining whether a snapshot image is stored on the server in association with a user; and
responsive to a snapshot image being stored on the server in association with a user, determining whether the machine type of the first client computer matches the machine type of the second client computer.

23. The method of claim 19, wherein the policy causes creation of a snapshot image periodically.

24. The method of claim 19, wherein the policy causes creation of a snapshot image in response to an occurrence of a selected event.

25. A distributed data processing system comprising:
a network;
a plurality of client computers connected to the network, wherein each of the plurality of computers has a system image and sends updates of the system image for storage in response to a selected event;
a server computer connected to the network, wherein the server computer maintains a copy of each system image as a stored system image, receives an update to a stored system image, and changes the stored system image to reflect the update.

26. The distributed data processing system of claim 25, wherein the update is a new system image which replaces the stored system image.

27. The distributed data processing system of claim 25, wherein the update is a change to the system image, which is used to change the stored system image.

28. A data processing system for maintaining a system image for the data processing system, the data processing system comprising:
identifying means for identifying an initial state of the system image;
determining means, responsive to an event, for determining whether a present state of the system image has changed from the initial state of the system image; and
sending means, responsive to a change between the initial state of the system image and the current state of the system image, for sending an update of the system image to a remote computer for storage.

29. The data processing system of claim 28, wherein the sending means comprises:
sending means for sending the change for storage.

30. The data processing system of claim 28, wherein the sending means comprises:
sending means for sending a snapshot of the system image for storage.

31. The data processing system of claim 28, wherein the remote computer is a server computer.

32. The data processing system of claim 28, wherein the event is a periodic event.

33. The data processing system of claim 28, wherein the event is a request from a user to update the image.

34. The data processing system of claim 28, wherein the event is a log off of the computer.

35. The data processing system of claim 28, wherein the data processing system includes registers and wherein the system image includes a state of the registers.

36. The data processing system of claim 28, wherein active applications are present on the data processing system and wherein the system image includes the active applications.

37. A computer for maintaining system images for a plurality of users at a plurality of client computers in a distributed data processing system, the computer comprising:
maintaining means for maintaining a plurality of system images for the plurality of users within the computer, wherein each system image within the plurality of system images is associated with a user within the plurality of users;
monitoring means for monitoring for a reception of an update to a system image from a client computer within the plurality of client computers;
identifying means, responsive to detecting the reception of the update to a system image, for identifying a system image within the plurality of system images that is associated with the update; and
changing means, responsive to identifying the system image associated with the update, for changing the system image to reflect the update.

38. The computer of claim 37, wherein the update is a new system image.

39. The computer of claim 37, wherein the update is a change to the system image.

40. The computer of claim 37, wherein the update includes a state of registers in a client computer.

41. The computer of claim 37, wherein the update includes a state of memory in a client computer.

42. The computer of claim 37 further comprising:
monitoring means for monitoring for a login by a user at a client computer;
determining means, responsive to detecting a login by the user, for determining whether a system image for the user is present; and
sending means, responsive to determining that the system image for the user is present, for sending the image to the client computer.

43. The computer of claim 42 further comprising:
sending means, responsive to determining the system image for the user is absent, for sending a default image to the client computer.

44. A data processing system for computing in a distributed data processing system, the data processing system comprising:
creating means for creating a snapshot image of a first client computer within the distributed data processing system on a periodic basis;
storing means for storing the snapshot image on a server computer within the distributed data processing system in association with a user;
determining means, responsive to the user logging on to a second client computer within the distributed data processing system, for determining whether the snapshot image is available; and
loading means, responsive to determining that the snapshot image is available, for loading the snapshot image onto the second client computer.

45. The data processing system of claim 44, wherein the snapshot image includes system memory, disk images, and network and processor states.

46. The data processing system of claim 44 further comprising creating the snapshot image of the first client computer in response to an occurrence of a selected event in the first client computer.

47. The data processing system of claim 44, wherein the first client computer has a machine type, the second client computer has a machine type, and wherein the determining means determining whether the snapshot image is available comprises:
first determining means for determining whether a snapshot image is stored on the server in association with a user; and
second determining means, responsive to a snapshot image being stored on the server in association with a user, for determining whether the machine type of the first client computer matches the machine type of the second client computer.

48. A computer program product in a computer readable medium for maintaining a system image for the computer, the computer program product comprising:
first instructions for identifying an initial state of the system image;
second instructions, responsive to an event, for determining whether a present state of the system image has changed from the initial state of the system image; and
third instructions, responsive to a change between the initial state of the system image and the current state of the system image, for sending an update of the system image to a remote computer for storage.

49. A computer program product in a computer readable medium for maintaining system images on a host computer for a plurality of users at a plurality of client computers in a distributed data processing system, the computer program product comprising:
first instructions for maintaining a plurality of system images for the plurality of users within the host computer, wherein each system image within the plurality of system images is associated with a user within the plurality of users;
second instructions for monitoring for a reception of an update to a system image from a client computer within the plurality of client computers;
third instructions, responsive to detecting the reception of the update to a system image, for identifying a system image within the plurality of system images that is associated with the update; and
fourth instructions, responsive to identifying the system image associated with the update, for changing the system image to reflect the update.

50. A computer program product in a computer readable medium for computing in a distributed data processing system, the computer program product comprising:
first instructions for creating a snapshot image of a first client computer within the distributed data processing system on a periodic basis;
second instructions for storing the snapshot image on a server computer within the distributed data processing system in association with a user;
third instructions, responsive to the user logging on to a second client computer within the distributed data processing system, for determining whether the snapshot image is available; and
fourth instructions, responsive to determining that the snapshot image is available, for loading the snapshot image onto the second client computer.
